(19) United States
(12) Patent Application Publication
(10) Pub. No.: US 2020/0200617 A1
(43) Pub. Date: Jun. 25, 2020

(54) PRESSURE SENSOR AND METHOD FOR MANUFACTURING PRESSURE SENSOR

(71) Applicant: NIPPON MEKTRON, LTD., Tokyo (JP)

(72) Inventor: Ryoichi TOYOSHIMA, Tokyo (JP)

(73) Assignee: NIPPON MEKTRON, LTD., Tokyo (JP)

(21) Appl. No.: 16/621,223

(22) PCT Filed: Mar. 26, 2019
(86) PCT No.: PCT/JP2019/012849

§ 371 Date: Dec. 10, 2019

(30) Foreign Application Priority Data
Apr. 16, 2018 (JP) 2018-078208

(51) Int. Cl. G01L 1/20; G01L 5/00

(52) U.S. Cl. CPC G01L 1/20; G01L 5/00

(57) ABSTRACT

Provided is a pressure sensor that is suitable for measuring a wide range of pressures and has a small footprint. The pressure sensor is constituted by a wiring sheet 10 having: a plurality of sensor devices U1 and U2 including electrodes 19a and 19b, and a conductive film 15 disposed opposite to the electrodes 19a and 19b, and stacked in a direction in which the conductive film 15 is disposed against the electrodes 19a and 19b; a common input line 21 for inputting electrical signals to the plurality of sensor devices U1 and U2; and a common output line 22 for outputting the electrical signals from the plurality of sensor devices.

### TECHNICAL FIELD

The present invention relates to a pressure sensor and a method for manufacturing the pressure sensor.

### BACKGROUND ART

The pressure sensor for sensing pressure is used in various technical fields. Some types of pressure sensors are used in mobile terminals, robots and the like. It is desired that the pressure sensor for such an application can be installed in a relatively narrow range. That is, its footprint is desirably small. Further, the pressure sensor is required to detect a position where a pressure is received with high accuracy. Known examples of pressure sensors are described in, for example, PATENT LITERATURE 1, PATENT LITERATURE 2, and PATENT LITERATURE 3. A control device for a robot hand described in PATENT LITERATURE 1 has a gripping portion of workpiece in the robot and a pressure detection sensor used to detect a contact pressure with the workpiece. PATENT LITERATURE 2 describes a seating sensor including a plurality of sensitive sensors connected in parallel. PATENT LITERATURE 3 describes a membrane switch including a spacer provided between a pair of insulating films and has an open contact portion, and electrodes respectively formed on opposing surfaces of the opening. Further, it is described that a protruding portion is provided on an outer surface of at least one insulating film of the contact portion.

### CITATION LIST

### Patent Literature

PATENT LITERATURE 1: JP-A-07-186078

PATENT LITERATURE 2: JP-A-2003-065865

PATENT LITERATURE 3: JP-A-2000-222982

### SUMMARY OF THE INVENTION

### Problems to be Solved by the Invention

However, the pressure sensor disclosed in PATENT LITERATURE 1 detects the contact pressure at a plurality of locations. Then, it is determined whether only a pressure value detected at any one of a plurality of contact pressures on a straight line in vertical, horizontal, and oblique directions is equal to or greater than a predetermined value. Therefore, the pressure sensor disclosed in PATENT LITERATURE 1 requires a plurality of pressure sensors respectively arranged in a plurality of directions. Therefore, an area required for installing the pressure sensors is increased. Further, according to an embodiment described in PATENT LITERATURE 2, the plurality of pressure sensors is provided in a passenger seat of the automobile. Then, influence of electrical resistance value detected by each of the pressure sensors on a total resistance is reduced. This prevents false detection of human seating. Therefore, the embodiment described in PATENT LITERATURE 2 is not intended to solve a problem related to the footprint of the pressure sensor, either. Further, in the embodiment described in PATENT LITERATURE 3, the resistance value of the pressure sensor varies greatly even with a relatively small value of load. That is, the pressure sensor can measure a relatively small pressure with high sensitivity. However, there is no effect on measuring a large pressure. Therefore, the pressure sensor has a disadvantage that a dynamic range of its measurement is narrow. The pressure sensor according to the present embodiment has been developed in view of the above points. That is, the present disclosure relates to the pressure sensor capable of measuring the pressure in a wide range (measurement range) of measurable pressure and is suitable for reducing the footprint, and the method for manufacturing the pressure sensor.

### Solution to the Problems

A pressure sensor according to the present embodiment includes: a plurality of sensor devices; and a wiring sheet. Each of the plurality of sensor devices includes electrodes and a conductive film disposed to face the electrodes. The plurality of sensor devices is stacked in a direction in which the conductive film is disposed against the electrodes, and the wiring sheet includes a common input line for inputting electrical signals to the plurality of sensor devices, and a common output line for outputting the electrical signals from the plurality of sensor devices.

A method for manufacturing a pressure sensor according to the present embodiment includes forming on a wiring sheet, sensor devices each including a plurality of electrodes and a conductive film corresponding to at least one electrode of the plurality of electrodes, a common input line for inputting electrical signals to the sensor devices, and a common output line for outputting the electrical signals from the sensor devices, and stacking the sensor devices by folding the wiring sheet.

### Effects of the Disclosure

According to the present disclosure, the pressure sensor capable of measuring a wide range of pressures within the measurement range and suitable for reducing the footprint, and a method for manufacturing the pressure sensor are provided.

### BRIEF DESCRIPTION OF THE DRAWINGS

FIG. 1 is a schematic cross-sectional view for explaining a pressure sensor according to an embodiment of the present disclosure.

FIG. 2(a) is a schematic top view of a sensor device of the pressure sensor shown in FIG. 1. FIG. 2(b) is a schematic cross-sectional view of the sensor device.

FIG. 3(a) is a cross-sectional view of the sensor device of modification. FIG. 3(b) is a view for explaining folding of the sensor device of FIG. 3(a). FIG. 3(c) is a cross-sectional view of a configuration including the folded sensor device of FIG. 3(b).

FIG. 4 is a top view of the pressure sensor including stack circuits shown in FIGS. 1, 2(a) and 2(b), that are connected in parallel.

FIG. 5 is a diagram showing an equivalent circuit of the pressure sensor shown in FIG. 4.

FIG. 6(a), FIG. 6(b), and FIG. 6(c) are views for explaining a method for manufacturing the pressure sensor of the present embodiment.

FIG. 7(a), FIG. 7(b), and FIG. 7(c) are views for explaining the method for manufacturing another pressure sensor of the present embodiment.

FIG. 8(a), FIG. 8(b), and FIG. 8(c) are views for explaining another example of the method for manufacturing the pressure sensor of the present embodiment.

FIGS. 9(a) and 9(b) are views for explaining a modification 1 of the embodiment of the present disclosure.

FIGS. 10(a) to 10(c) are views for explaining a modification 2 of the embodiment of the present disclosure.

FIGS. 11(a) and 11(b) are diagrams for explaining an example of the present disclosure, and are the diagrams showing verification results of effects obtained by stacking the sensor devices.

FIGS. 12(a) and 12(b) are diagrams for explaining the example of the present disclosure, and are the diagrams showing the verification results of the effects when resistance characteristics of the stacked sensor devices are different to each other.

FIGS. 13(a) to 13(c) are diagrams for explaining the example of the present disclosure, and are the diagrams showing the verification results of the effects obtained by connecting the stacked sensor devices in parallel or in series.

### DESCRIPTION OF THE EMBODIMENTS

### [Overview]

An embodiment of the present disclosure will be described with reference to the drawings below. In all the drawings, the same components are denoted by the same reference numerals. Then, overlapping description will be omitted as appropriate. A basic configuration of a pressure sensor of the present embodiment includes a sheet-like wiring board (hereinafter referred to as a wiring sheet) containing a flexible material processed into a sheet shape, and a wiring layer formed on the wiring sheet.

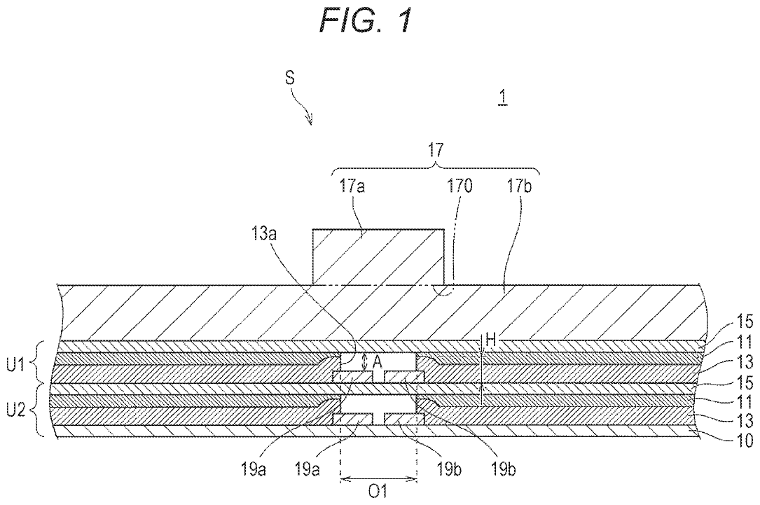

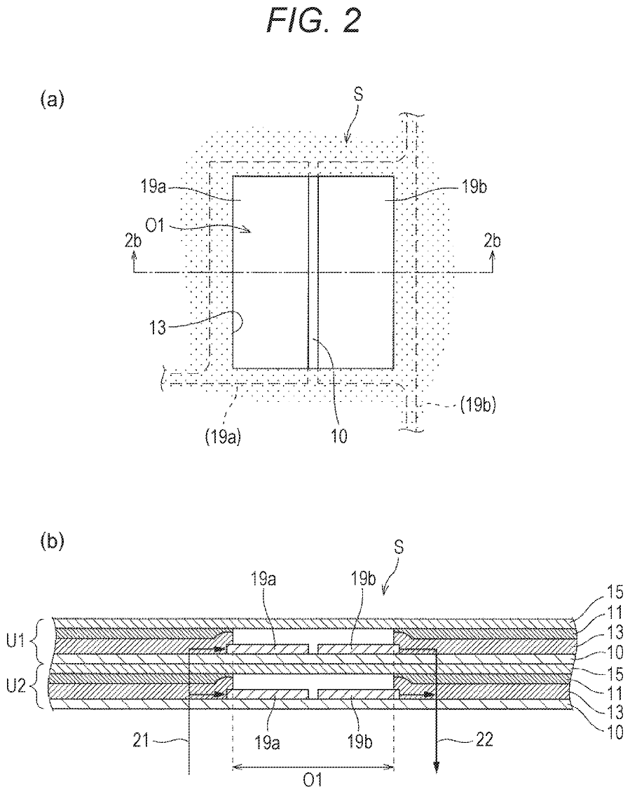

FIG. 1 is a schematic cross-sectional view for explaining a pressure sensor 1 of the present embodiment. FIGS. 2(a) and 2(b) are schematic views for enlarging and explaining sensor devices U1 and U2 shown in FIG. 1. In FIGS. 2(a) and 2(b), the wiring sheet of the pressure sensor is used as a reference (lowermost layer). A direction from a side closer to the wiring sheet (a lower side of the drawing) to a side farther from the wiring sheet (an upper side of the drawing) is defined as an up-down direction. The up-down direction does not necessarily coincide with an up-down direction of a product itself in which the pressure sensor is incorporated. The sheet shape refers to a thin plate-like or film-like shape having a side surface that is sufficiently small so that the wiring sheet is flexible compared to a forming surface (an upper surface) of the wiring sheet on which the wiring layer is formed and a back surface (a lower surface) with respect to the upper surface. Whether it is a sheet shape does not depend only on thickness of the material. FIG. 2(a) is a schematic top view of the sensor device U1 of the pressure sensor 1. FIG. 2(b) is a schematic cross-sectional view of the sensor device U1 or U2 taken along an arrow line 2b-2b in FIG. 2(a).

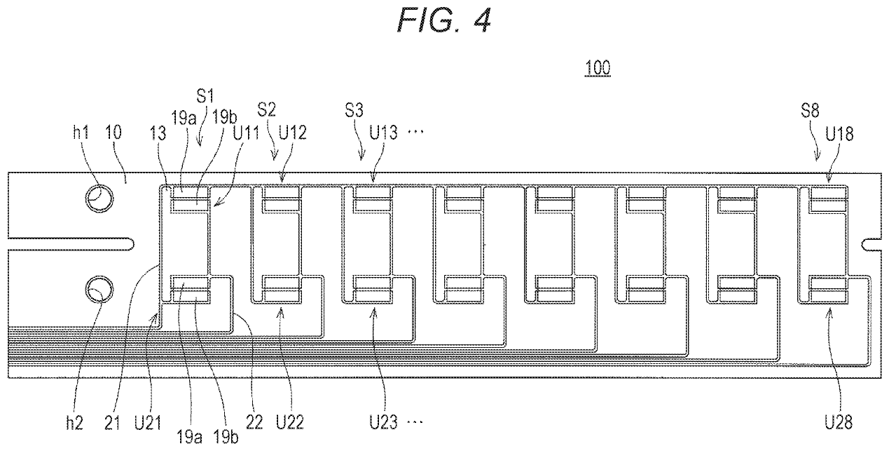

As shown in FIGS. 1, 2(a) and 2(b), the pressure sensor 1 includes the sensor devices U1 and U2. Each of the sensor devices U1 and U2 includes two electrodes 19a and 19b that are spaced apart from each other by a predetermined distance, and a conductive film 15 that is disposed to face the electrodes 19a and 19b. Further, the sensor devices U1 and U2 are stacked on each other in a direction in which the conductive film 15 is disposed against the electrodes 19a and 19b. As shown in FIG. 2(b), the pressure sensor 1 also includes a wiring sheet 10. The wiring sheet 10 includes a common input line 21 that inputs electrical signals to the two sensor devices U1 and U2, and a common output line 22 that outputs the electrical signals from a plurality of sensor devices U1 and U2 (FIG. 4). The sensor devices U1 and U2 have the same configuration.

The sensor devices U1 and U2 shown in FIGS. 2(a) and 2(b) are stacked on each other. The input line 21 and the output line 22 are shared by them. Therefore, the stacked sensor devices constitute a circuit for outputting one detection signal (hereinafter referred to as a pressure-sensitive signal). Such a circuit is hereinafter also referred to as a stack circuit S in the present embodiment. A plurality of stack circuits S is provided on the wiring sheet 10. In the present embodiment, all of the sensor devices U1 and U2 formed on the wiring sheet 10 need not be limited to the stack circuit S. Elements having other configurations may be present on the wiring sheet 10.

As shown in FIG. 1, the electrodes 19a and 19b are formed on the wiring sheet of the pressure sensor 1. Thus, the pressure sensor 1 is constituted by the electrodes incorporated on the wiring sheet 10. Therefore, the present embodiment has a configuration advantageous for reducing thickness of the stack circuit S.

In an example shown in FIG. 1, a part of the plurality of sensor devices U1 and U2 includes a protrusion 17a that overlaps at least a part of the electrodes 19a and 19b. In this example, the protrusion 17a exists on the sensor device U1 side. Thus, the sensor device U1 is configured so that a load is concentrated on the electrodes 19a and 19b. In this example, the sensor device U1 includes the protrusion 17a. Further, in the pressure sensor 1 shown in FIG. 1, one protrusion 17a is provided corresponding to all the plurality of sensor devices U1 and U2 which are stacked on each other. In a configuration including one protrusion 17a provided corresponding to the plurality of sensor devices U1 and U2, the number of protrusions 17a in the stack circuit S is reduced. Therefore, it is advantageous for making the stack circuit S thin. Further, a shape of the protrusion 17a is not particularly limited. That is, the protrusion 17a can be appropriately formed in any shape out of a quadrangular prism, a column, a substantially spherical body, and the like. Therefore, an end surface 170 of the protrusion 17a (a lower end surface of the protrusion 17a in FIG. 1; hereinafter referred to as a protrusion end surface) that transmits a pressing force from the device and the outside to the sensor device may also have any shape.

The protrusion 17a of the present embodiment is a protrusion that protrudes upward from a base portion 17b. The base portion 17b is a member generated when the protrusion 17a is injection molded. A member having a configuration including a combined protrusion 17a and base portion 17b is referred to as an electrode pressing material 17. The protrusion end surface 170 is a virtual surface corresponding to a boundary between the protrusion 17a and the base portion 17b. However, the present embodiment is not limited to the embodiment in which the sensor devices U1 and U2 are stacked on each other so that directions thereof (directions from the electrode 19 toward the conductive film 15) are the same, as shown in FIGS. 1 and 2(b). The sensor devices U1 and U2 may be stacked so that the direction of the sensor device U1 is opposite to the direction of the sensor device U2.

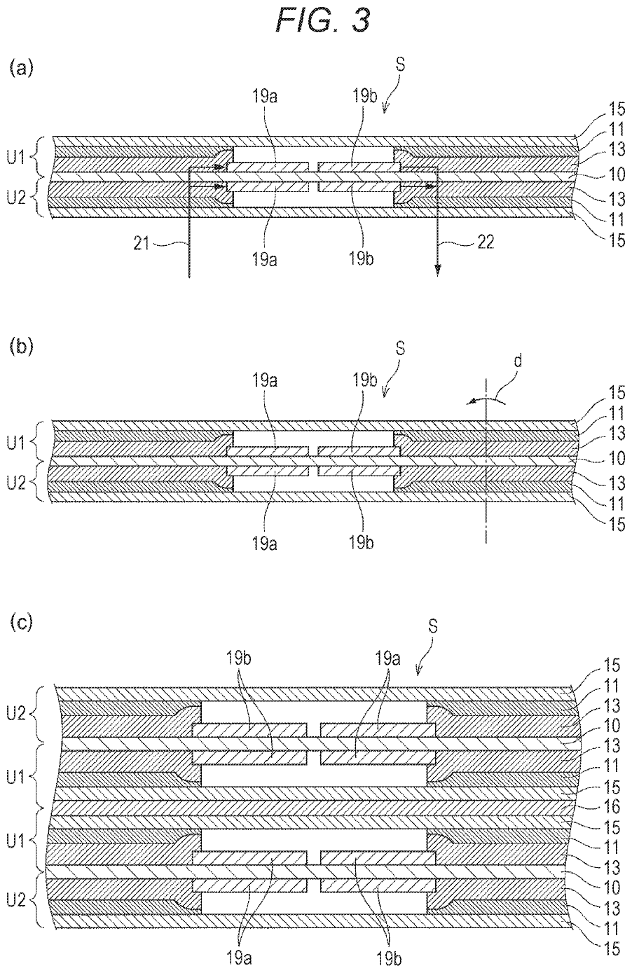

FIG. 3(a) shows an embodiment in which the sensor devices U1 and U2 are stacked on each other so that the directions of the sensor device U1 and the sensor device U2 are opposite to each other. In the present embodiment, the wiring sheet 10 is disposed inside them. In this case, the sensor devices U1 and U2 may individually have the wiring sheet 10. However, as shown in FIG. 3(a), the sensor devices U1 and U2 may share the single-layer wiring sheet 10. Thus, thickness of the pressure sensor can be reduced. The pressure sensor 1 having a small thickness is advantageous for reducing its footprint by further stacking the sensor devices U1 and U2. FIG. 3(b) is a view showing how the pressure sensor shown in FIG. 3(a) is folded. In the present embodiment, as shown in FIG. 3(b), the pressure sensor is folded back in a direction (vertical direction) indicated by an arrow lined with a one-dot chain line shown in FIG. 3(b) as a boundary. Thus, more sensor devices U1 and U2 can be stacked. FIG. 3(c) is a cross-sectional view of the pressure sensor manufactured by folding the pressure sensor shown in FIG. 3(a) as shown in FIG. 3(b). In the pressure sensor shown in FIG. 3(c), an insulating sheet 16 provided between the stacked conductive films 15 prevents conduction between two adjacent sensor devices U1. Further, in the pressure sensor shown in FIG. 3(c), the electrode pressing material 17 can be provided in any side of the upper and lower conductive films 15 which are the outermost layers.

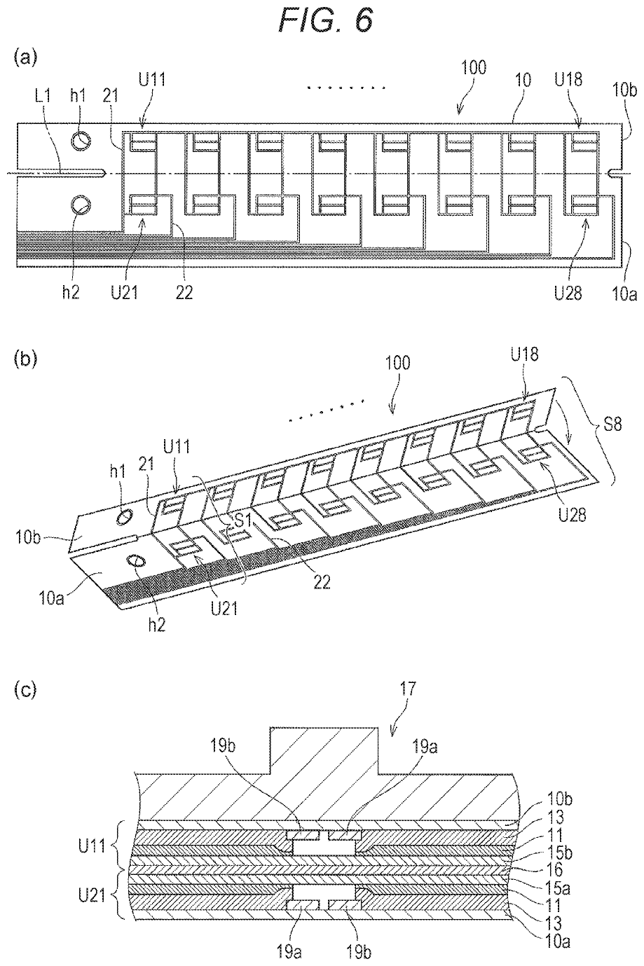

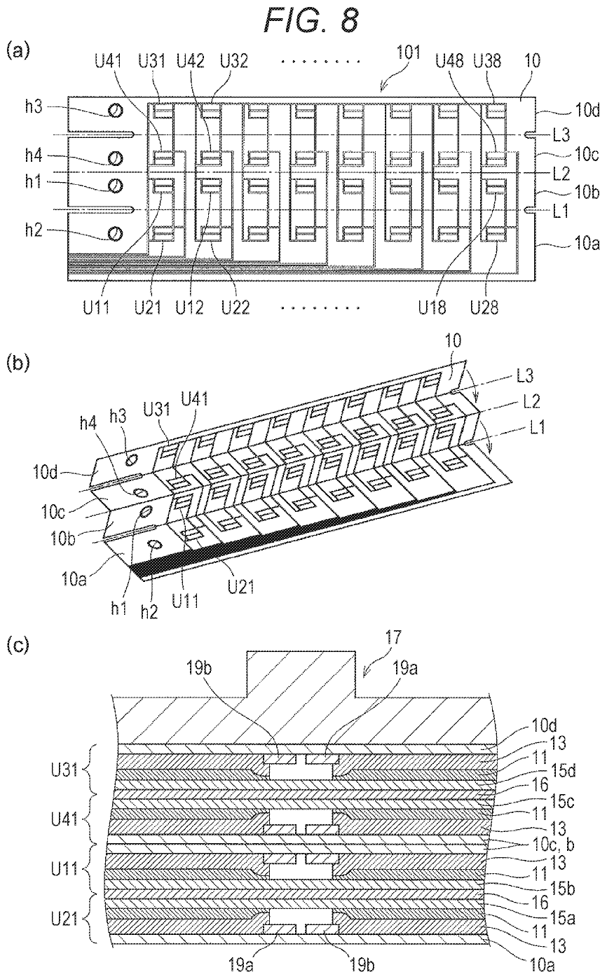

Further, the conductive film 15 may be disposed inside them. As a result, the sensor devices U1 and U2 may be stacked so that the insulating sheet 16 is sandwiched between the sensor devices U1 and U2 from above and below. Also in this case, the direction of the sensor device U1 is opposite to the direction of the sensor device U2. Such an embodiment will be described below with reference to FIGS. 6(c) and 8(c). In this case, in FIG. 6(c), the insulating sheet 16 is inserted between two conductive films 15a and 15b corresponding to the sensor devices U11 and U21 so that the two conductive films 15a and 15b are not electrically short-circuited. Similarly in FIG. 8(c), insulating sheets 16 are respectively inserted between the conductive films 15a and 15b corresponding to the sensor devices U11 and U21, and between the conductive films 15c and 15d corresponding to the sensor devices U31 and U41. Further, in FIG. 6(c), the sensor device U11 and the sensor device U21 may be stacked so that a positional relationship between the wiring sheet 10b and the conductive film 15b is reversed from a configuration shown in FIGS. 1, 2(a) and 2(b) (the wiring sheet 10 below the conductive film 15 in FIGS. 1, 2(a) and 2(b) is above the conductive film 15 in FIG. 6(c)). Similarly in FIG. 8(c), the positional relationship between the wiring sheet 10b and the conductive film 15b may be configured to be reversed from the configuration shown in FIGS. 1, 2(a) and 2(b). That is, the sensor device U11 and the sensor device U21 may be stacked so that the wiring sheet 10 below the conductive film 15 in FIGS. 1, 2(a) and 2(b) is above the conductive film 15 in FIG. 8(c). Further, similarly in FIG. 8(c), the sensor device U31 and the sensor device U41 may be stacked so that the positional relationship between the wiring sheet 10d and the conductive film 15d is reversed from the configuration shown in FIGS. 1, 2(a) and 2(b).

In the example shown in FIG. 1, the one protrusion 17a is provided corresponding to the sensor devices U1 and U2. However, the present embodiment is not limited to such a configuration. The protrusion 17a may be provided in each of the stacked sensor devices. When the protrusion 17a is provided in each of the sensor devices U1 and U2, the protrusion 17a may be provided outside the stacked sensor devices U1 and U2. Or the protrusion 17a may be provided between the sensor devices U1 and U2, that is, in the stack circuit S. Further, in the present embodiment, one protrusion 17a of the sensor device U1 or the sensor device U2 is provided outside the stack circuit S. On the other hand, the other protrusion 17a may be provided inside the stack circuit. In any of the above configurations, the pressing force applied to the pressure sensor 1 is reliably concentrated on the electrodes 19a and 19b. Therefore, the protrusion 17a can increase sensitivity of the pressure sensor 1.

When the protrusions 17a are formed on the sensor devices of the stack circuits S that are stacked on each other, a part of the protrusion end surfaces 170 of the protrusions may be configured to have different sizes from the protrusion end surfaces 170 of other protrusions. In this way, a characteristic related to resistance of the sensor device constituting the stack circuit S will differ. Here, the characteristic related to the resistance of the sensor device refers to a physical or chemical characteristic that can affect an electrical resistance value of the sensor device among various parameters of the pressure sensor 1. For example, it is assumed that the electrodes 19a, 19b and the conductive film 15 are pressed uniformly with a constant pressure stress (pressing force per unit area). At this time, it is assumed that a contact area between the electrodes 19a, 19b and the conductive film 15 is increased or decreased. In this case, when the contact area is increased, electrical conduction between the electrodes 19a and 19b and the conductive film 15 is facilitated. Therefore, the resistance of the sensor device is reduced. On the other hand, when the contact area between the electrodes 19a, 19b and the conductive film 15 is decreased, the resistance of the sensor device is increased. Therefore, the contact area between the electrodes 19a, 19b and the conductive film 15 and the parameters that affect the contact area are examples of characteristics related to the resistance of the sensor device. Significance of changing the characteristics related to the resistance of the sensor devices U1 and U2 included in the stack circuit S in this way will be described below.

The pressure sensor 1 has an insulating layer 13 in addition to the above configuration. The insulating layer 13 of the pressure sensor 1 shown in FIGS. 1, 2(a) and 2(b) covers substantially an entire surface of the wiring sheet 10 except for a part of formation region of the electrodes 19a and 19b, to protect the input line 21 and the output line 22. At the same time, the insulating layer 13 improves its environmental resistance. The insulating layer 13 is opened on the electrodes 19a and 19b. An opening O1 of the insulating layer 13 is shown in FIGS. 1, 2(a) and 2(b). The electrodes 19a and 19b can be in contact with the conductive film 15 in a region of the opening O1. Therefore, in the pressure sensor 1 shown in FIGS. 1, 2(a) and 2(b), when an area of the opening O1 is large, resistance values of the electrodes 19a, 19b and the conductive film 15 are small. Therefore, an opening area of the opening O1 is determined depending on application of the pressure sensor 1 and a range of appropriate detection values.

An adhesive layer 11 is formed between the conductive film 15 and the insulating layer 13. The adhesive layer 11 maintains separation between the conductive film 15 and the electrodes 19a and 19b when no pressing force is applied to the pressure sensor.

Next, the configuration described above will be described in detail.

### [Wiring Sheet]

The wiring sheet 10 of the present embodiment is a flexible and insulating film, and is a so-called flexible printed wiring board. Examples of materials for the insulating film include polyethylene, polyethylene terephthalate, polyethylene naphthalate, cycloolefin polymer, polycarbonate, aramid resin, polyimide, polyimide varnish, polyamideimide, polyamideimide varnish, and flexible sheet glass. However, the examples of the materials are not limited thereto. If high temperature durability in a usage environment of the pressure sensor 1 is taken into consideration, the material of the wiring sheet 10 is more preferably polycarbonate, aramid film, polyimide, polyimide varnish, polyamideimide, polyamideimide varnish, flexible sheet glass, or the like having high heat resistance. When providing a process such as soldering in manufacturing the pressure sensor 1, the material of the wiring sheet 10 is still more preferably a polyimide film, a polyimide varnish film, a polyamideimide film, or a polyamideimide varnish film. Although thickness of the wiring sheet 10 is not specifically limited, it can be set in a range of, for example, 12.5 μm or more and 50 μm or less. When the thickness of the wiring sheet 10 exceeds 12.5 μm, good durability is exhibited during a manufacturing process or use of the pressure sensor 1. Further, when it is less than 50 μm, good flexibility is exhibited. Therefore, the wiring sheet 10 can be satisfactorily used by arranging or bending the wiring sheet 10 on a curved surface. As described above, the wiring sheet 10 may be previously formed into a film shape. Or it may be formed by casting and applying an insulating varnish such as polyimide to a Cu foil or the like that is a material of the electrodes 19a and 19b. For example, the thickness of the wiring sheet 10 may be designed to be larger than that of the conductive film 15 from a viewpoint of improving both durability and high sensitivity characteristics of the pressure sensor 1.

### [Electrode]

The electrodes 19a and 19b are a pair of electrodes arranged in parallel at a predetermined distance in a plane direction. The electrodes 19a and 19b are formed on the wiring sheet 10 in a desired pattern shape. The sensor devices U1 and U2 of the present embodiment individually have the wiring sheet 10 and the electrodes 19a and 19b. That is, the stack circuit S of the present embodiment shown in FIG. 2(b) is configured to include two wiring sheets 10 and two conductive films 15 facing each other. The electrodes 19a and 19b are respectively formed on the same surface side (an upper surface side in the drawing) of each of the wiring sheets 10. By providing the electrodes 19a and 19b on one side of the wiring sheet 10 in this way and stacking them, it is possible to manufacture the pressure sensor 1 at a lower cost compared to a modification shown in FIG. 2(c).

As shown in FIGS. 1, 2(a) and 2(b), each of the electrodes 19a and 19b of the present embodiment has a rectangular shape when viewed from above. In addition, they are adjacently arranged in parallel at the predetermined distance. A combined resistance value of the electrodes 19a and 19b varies depending on a distance between the electrodes 19a and 19b. The electrode 19a and the electrode 19b of the present embodiment are formed in the same shape and the same size. However, the present embodiment is not limited to this. The electrode 19a and the electrode 19b may have different shapes. Or it may be similar and have different sizes.

The distance between the electrodes 19a and 19b is not particularly limited. The distance can be determined based on a distance between the electrodes 19a, 19b and the conductive film 15. For example, when a distance A between the electrodes 19a, 19b and the conductive film 15 is 5 μm or more and 25 μm or less, the distance between the counter electrodes can be designed in a range of 10 μm or more and 500 μm or less. Thus, suitable pressure-sensitive characteristics and manufacturing stability can be obtained. At this time, a thickness of the electrodes 19a and 19b is preferably 9 μm or more and 20 μm or less.

The electrodes 19a and 19b are made of a conductive member. In the present embodiment, the electrodes 19a and 19b are made of a low-resistance metal material. In the present embodiment, surface resistivity of the electrodes 19a and 19b is designed to be smaller than that of the conductive film 15. Specifically, the electrodes 19a and 19b are preferably formed from copper, silver, a metal material containing copper or silver, aluminum, or the like. However, the material is not limited thereto. Further, form of the material can be appropriately determined by combining with a method for manufacturing the electrodes 19a and 19b in addition to foil, paste or the like.

### [Input Line and Output Line]

The electrode 19a and the electrode 19b are connected to the input line 21 and the output line 22 formed on the wiring sheet 10. One end of the input line 21 is connected to a power source (not shown). The other end of the input line 21 is connected to, for example, all of the sensor devices U1 and U2 formed on the wiring sheet 10. With this connection, current or voltage is supplied to the sensor devices U1 and U2. The output line 22 is connected to a driver device (not shown) of the pressure sensor 1. The output line 22 is common to the sensor devices U1 and U2 constituting one stack circuit. One pressure-sensitive signal is output from one stack circuit S. Therefore, the pressure-sensitive signal of the present embodiment is a combined value of the resistance values detected by the sensor devices U1 and U2.

The input line 21 and the output line 22 may be formed only on one surface of the wiring sheet 10. Or any or all of the input line 21 and the output line 22 may be drawn out through a through-hole (TH) to a surface opposite to a surface of the wiring sheet 10 on which the electrodes 19a and 19b are formed. The input line 21 and the output line 22 drawn out to the opposite surface may be drawn out again to the surface on which the electrodes 19a and 19b are formed through the through-hole (TH). Thus, the wiring sheet 10 of the present embodiment may be a double-sided board on which the input line 21 and the output line 22 are arranged on both sides thereof. Or the wiring sheet 10 may be a single-sided board. In addition, the electrodes 19a and 19b may be disposed on both surfaces of the common wiring sheet 10 so as to face each other, and the conductive films 15 may be disposed on both upper and lower sides thereof. FIG. 3(b) is a cross-sectional view of the sensor device according to a modification of the present embodiment which shows such a structure. The wiring sheet 10 of the present modification including the sensor devices U1 and U2 may be stacked, for example, by being further folded to form a multilayer sensor device having four or more layers. According to the present modification shown in FIG. 3(b), the wiring sheet 10 can be reduced by one layer as compared with the embodiment shown in FIG. 2(b). Therefore, the pressure sensor 1 can be thinned

### [Insulating Layer and Adhesive Layer]

Next, the insulating layer 13 and the adhesive layer 11 will be described. The insulating layer 13 is provided on the upper surface of the wiring sheet 10 provided with the electrodes 19a and 19b. The insulating layer 13 forms a spacer for separating the electrodes 19a and 19b from the conductive film 15 by a predetermined distance A (see FIG. 1) on the electrodes 19a and 19b together with the opening O1 so that at least a part of the electrodes 19a and 19b are in contact with the conductive film 15. In an initial state, the electrodes 19a, 19b and the conductive film 15 are separated from each other due to presence of the insulating layer 13 and the adhesive layer 11. Therefore, the electrodes 19a and 19b are not conductive. As the distance A is increased, the pressing force required to bring the conductive film 15 into contact with the electrodes 19a and 19b is increased. By that amount, when a predetermined pressing force is applied to the pressure sensor 1, a deformation amount of the sensor devices U1 and U2 is reduced. As a result, a resistance between the electrodes 19a, 19b and the conductive film 15 is increased. Therefore, the distance A between the electrodes 19a, 19b and the conductive film 15 is an example of characteristics related to the resistance of the sensor device.

An end portion of the insulating layer 13 on a side close to the opening O1 may run on the electrodes 19a and 19b as shown in FIG. 1. In this case, the maximum height H of the insulating layer 13 is larger than a thickness of the insulating layer 13 in other regions sufficiently away from the electrodes 19a and 19b. Since the maximum height H of the insulating layer 13 is one of factors that determine the distance A between the electrodes 19a, 19b and the conductive film 15, the maximum height H is also an example of characteristics related to the resistance of the sensor device.

An opening size of the opening O1 is not particularly limited, and may be determined as appropriate without departing from the spirit of the present disclosure. For example, when the sensor devices U1 and U2 shown in FIG. 1 have a longitudinal dimension of 1.7 mm and a lateral dimension of 1.25 mm, the opening O1 can be set to have the longitudinal dimension of 1.5 mm and the lateral dimension of 1.05 mm. In such a case, the electrodes 19a and 19b are offset by 0.2 mm (0.1 mm on each side) with respect to the opening O1. In the present embodiment, a solder resist can be used as the insulating layer 13. A material for the solder resist is not particularly limited. By exposure and development using a photosensitive material such as a photosensitive sheet or a photosensitive coating material, the opening O1 can be accurately formed. In particular, by adopting a screen printing method using the photosensitive material, the wiring sheet 10 can be coated so that the photosensitive material covers the electrodes 19a and 19b. Then, the preferred insulating layer 13 can be formed by exposing a predetermined portion to form the opening O1. Further, the opening O1 of the present embodiment has a rectangular shape as shown in FIG. 2(a). However, a shape of the opening O1 can be appropriately designed in a circular shape, a polygonal shape, or an indefinite shape depending on the shapes of the electrodes 19a and 19b.

An example of the photosensitive material is an epoxy-based resin to which flexibility is appropriately added by a known means such as urethane modification. By using the epoxy resin, it is possible to form the insulating layer 13 having appropriate flexibility, and heat resistance that can be subject to a reflow process.

The conductive film 15 is laminated on the upper surface of the insulating layer 13. In the present embodiment, the insulating layer 13 and the conductive film 15 are joined to each other through the adhesive layer 11. As the adhesive layer 11, any material such as a glue, an adhesive, a gluing sheet, or an adhesive sheet may be used, if the insulating layer 13 and the conductive film 15 can be joined. The adhesive layer 11 has an opening having a shape substantially the same as that of the opening O1 so that a contact resistance between the electrodes 19a, 19b and the conductive film 15 is not hindered. In the present embodiment, after the adhesive layer 11 is provided on one of the insulating layer 13 and the conductive film 15, the other may be bonded to the adhesive layer 11 while being aligned with the one of the insulating layer 13 and the conductive film 15.

### [Conductive Film]

The conductive film 15 is a member that conducts between the electrodes 19a and 19b by contacting the electrodes 19a and 19b. The conductive film 15 having a conductive function means that the conductive film 15 has electrical conductivity to the extent that the electrodes 19a and 19b can be energized through the conductive film 15 by pressing the conductive film 15 from the outside. Specifically, the conductive film 15 to which the pressing force is applied from the outside contacts over the electrode 19a and the electrode 19b. Thus, the electrode 19a and the electrode 19b are conducted.

The conductive film 15 in the present embodiment only needs to have the conductive function to the extent that the electrodes 19a and 19b are conducted by the conductive film 15 contacting the electrodes 19a and 19b. Therefore, the conductive film 15 may be, for example, a resin film containing carbon particles. The conductive film 15 is given the conductive function by the carbon particles. In other words, the resin film used as the conductive film 15 contains the carbon particles to the extent that the conductive function is exhibited. The resin film is flexible. Thus, since the resin film itself has the conductive function, the conductive film 15 can be made thin. Further, the conductive film 15 having good flexibility can be obtained. As a result, the pressure sensor 1 having a large dynamic range can be obtained.

The resin film constituting the conductive film 15 can be appropriately formed by using a known resin without departing from the spirit of the present disclosure. Specific examples of the resin include: polyester such as polyethylene terephthalate, polyethylene naphthalate, and cyclic polyolefin; polycarbonate; polyimide; polyamideimide; liquid crystal polymer and the like. The conductive film 15 can be formed by mixing one or more resin materials among the above-described resins. The carbon particles contained in the conductive film 15 are members for imparting conductivity to the conductive film 15. The carbon particle is a particulate carbon material. Examples of carbon particles include one or a combination of two or more of carbon black such as acetylene black, furnace black (Ketjen Black), channel black and thermal black, and graphite. However, the carbon particles are not limited to this example. The content, shape and particle size of the carbon particles in the conductive film 15 are not particularly limited as long as they do not depart from the spirit of the present disclosure. They can be appropriately determined within a range in which the electrodes 19a and 19b are conducted depending on the contact resistance between the conductive film 15 and the electrodes 19a and 19b.

A thickness of the conductive film 15 is preferably 6.5 μm or more and 40 μm or less. When the thickness is 6.5 μm or more, the durability of the conductive film 15 is ensured. Further, when the thickness is 40 μm or less, initial stage detection sensitivity when the electrically conductive film 15 is pressed is good. In addition, a wide dynamic range can be secured. The thickness of the conductive film 15 can be measured using a general hide gauge, upright gauge, or other thickness measuring means.

The surface resistivity of the conductive film 15 is preferably 7 kΩ/sq or more and 30 kΩ/sq or less. When the surface resistivity is within the above range, the conductive film 15 has a small variation in sensor resistance when a large load is applied thereto. And high electrical reliability can be shown. The surface resistivity of the conductive film 15 in a desired range can be adjusted by a blending amount of carbon particles contained in the conductive film 15. In other words, the blending amount of the carbon particles contained in the conductive film 15 may be determined using as an index that the surface resistivity of the conductive film 15 falls within the above range.

The conductive film 15 may be adjusted so that surface roughness Rz of its surface facing the electrodes 19a and 19b is 0.10 μm or more and 0.50 μm or less. Thus, film formability of the conductive film 15 is improved. In addition, the detection sensitivity of the contact resistance is stabilized. The surface roughness Rz of the conductive film 15 is measured by measurement using a general surface roughness meter or surface roughness analysis using a laser microscope.

Young's modulus of the conductive film 15 is preferably 5 GPa or less. Thus, the conductive film 15 can be sufficiently flexible. With a range of Young's modulus described above, change in the contact resistance accompanying increase in the pressing force applied to the conductive film 15 can be well quantified in the above-described preferred range of the predetermined distance A and the opening size of the opening O1. The method for producing the resin film containing carbon particles is not particularly limited. For example, a carbon particle-containing resin film can be produced by film-forming a composition obtained by appropriately kneading a mixture of one or more resins as raw materials and the carbon particles.

The conductivity, the surface resistivity, and the surface roughness of the conductive film 15 described above are parameters that affect a magnitude of the resistance value when the conductive film 15 contacts the electrodes 19a and 19b. Therefore, all are examples of characteristics related to the resistance of the sensor device. Further, when the thickness or Young's modulus of the conductive film 15 is large, displacement of the conductive film 15 when the predetermined pressing force is applied to the pressure sensor 1 is small. Therefore, as a result of the conductive film 15 being difficult to contact the electrodes 19a and 19b, the resistance of the sensor device is increased. Thus, these parameters are also examples of characteristics related to the resistance of the sensor device.

### [Electrode Pressing Material]

The electrode pressing material 17 is constituted by the protrusion 17a and the base portion 17b as described above. The protrusion 17a and the base portion 17b are integrally formed of the same material, for example, by injection molding. The base portion 17b is formed of a molten material for forming the protrusion 17a in the injection molding. Therefore, when the protrusion 17a can be directly formed on the conductive film 15, the electrode pressing material 17 does not include the base portion 17b. The material of the electrode pressing material 17 can be appropriately selected without departing from the spirit of the present embodiment. For example, a rubber material having a rubber hardness of 20 or more and 80 or less or a plastic material having a relatively low hardness is used. Examples of the rubber material include natural rubber, acrylic rubber, isoprene rubber, styrene butadiene rubber, butadiene rubber, chloroprene rubber, butyl rubber, ethylene propylene rubber, epichlorohydrin rubber, nitrile butadiene rubber, nitrile isoprene rubber, and silicon rubber. It is also possible to consider polyvinyl alcohol, ethylene-vinyl acetate copolymer, and the like as the plastic material.

As described above, the protrusion 17a may have any shape. However, the protrusion 17a preferably has a shape and area suitable for the protrusion end surface 170 to concentrate the load on the electrodes 19a and 19b. In order to reliably concentrate the load on the sensor devices U1 and U2 of one stack circuit S, the protrusion end surface 170 preferably has a size that overlaps the opening O1 and enters into the opening O1.

The pressure sensor 1 described above operates as follows. Electric power is supplied to the sensor devices U1 and U2 of the pressure sensor 1 through the input line 21. Since the electrodes 19a and 19b are separated from each other, when the pressing force is not applied to the pressure sensor 1, the electrodes 19a and 19b are not electrically conducted. When the pressing force is applied from above the pressure sensor 1, the pressing force acts on both of the stacked sensor devices U1 and U2. In the sensor devices U1 and U2, the conductive film 15 is pushed downward by the protrusion 17a. The pushed conductive film 15 contacts the electrodes 19a and 19b exposed from the opening O1. The conductive film 15 and the electrodes 19a, 19b are in contact with each other, so that the electrodes 19a and 19b are conducted. Then, the electrical signal is output from the output line 22 to the driver device (not shown). The driver device determines that the pressure sensor 1 has been turned on when the output detection signal becomes greater than or equal to a predetermined threshold value. And a magnitude of the detected pressure is determined by the magnitude of the detection signal after the pressure sensor 1 has been turned on.

The magnitude of the electrical signal output from the pressure sensor 1 varies depending on the area where the electrodes 19a and 19b contact the conductive film 15. Therefore, when the conductive film 15 is strongly pressed against the electrodes 19a and 19b, the contact area increases, so that the resistance value decreases. When the electrical signal increases, it is determined that a strong pressure is applied to the sensor devices U1 and U2. In the present embodiment, the sensor devices U1 and U2 that are stacked on each other in a pressure application direction constitute the stack circuit. Therefore, the contact area between the electrodes 19a, 19b and the conductive film 15 of the sensor device U1 to which the pressing force is transmitted first, and the contact area between the conductive film 15 and the electrodes 19a, 19b of the sensor device U2 may be different. In such a case, the combined resistance of the sensor device U1 and the sensor device U2 includes a low resistance component and a high resistance component. Therefore, in the pressure sensor 1, the electrical signal changes in a wider range depending on the pressure than when the pressure is applied to a sensor device that is not stacked (hereinafter referred to as a single sensor device). The present embodiment described above can provide a wide-range pressure sensor with a wide pressure measurement range.

In the above configuration, in the present embodiment, the stacked sensor devices included in the stack circuit S may be configured such that some of them have characteristics different from the characteristics related to the resistance of other sensor devices. In this way, when the pressing force is applied to the pressure sensor 1, a relatively large electrical signal is output from the sensor device having a relatively low resistance in the stack circuit S. On the other hand, a relatively small electrical signal is output from the sensor device having a relatively high resistance. At this time, the large electrical signal starts to be output at a relatively low pressure. Therefore, an initial sensitivity of the pressure sensor 1 can be increased. Further, the small electrical signal output from the sensor device having the high resistance changes until after the large electrical signal does not change. In the present embodiment, a combined value of the large and small electrical signals is output as a pressure detection signal. Therefore, it is possible to realize a wide-range pressure sensor 1 that can measure a wide range from low pressure to high pressure.

A method for changing the characteristics related to the resistance of the sensor device includes, for example, changing an area of the electrode that can be in contact with the conductive film. That is, a part of the stacked sensor devices used in the present embodiment may be configured such that the area of the electrode that can be in contact with the conductive film 15 is different from that of other sensor devices. As a configuration for changing the area of the electrode that can be in contact with the conductive film 15, for example, it is conceivable to change the opening area of the opening O1 between the sensor devices included in the stack circuit S. Further, it is also conceivable to change the areas themselves of the electrodes 19a and 19b.

Further, in the present embodiment, a range where a concentrated load is applied between the conductive film 15 and the electrodes 19a, 19b may be different between the sensor devices. In order to realize such a configuration, for example, when the plurality of sensor devices is provided in the stack circuit S, a size of the protrusion end surface 170 of a part of the protrusions 17a can be designed to be different from the size of the protrusion end surface 170 of the protrusions 17a of other sensor devices. It is assumed that the pressing force from the outside applied to the protrusion 17a is constant. In this case, the pressing force is dispersed by providing the protrusion 17a having a large area of the protrusion end surface 170. Therefore, the resistance between the electrodes 19a, 19b and the conductive film 15 is increased. Conversely, by providing the protrusion 17a having a small area of the protrusion end surface 170, the pressing force from the outside is concentrated. Thus, the resistance between the electrodes 19a, 19b and the conductive film 15 is reduced. Therefore, the relatively small electrical signal is output from the sensor device corresponding to the large protrusion end surface 170. The relatively large electrical signal is output from the sensor device corresponding to the small protrusion end surface 170. Therefore, a parameter of the area of the protrusion end surface 170 is an example of characteristics related to the resistance of the sensor device. At this time, the large electrical signal corresponding to the small protrusion end surface 170 starts to be output at a relatively low pressure. Therefore, the initial sensitivity of the pressure sensor 1 can be increased. Further, the small electrical signal output from the sensor device corresponding to the large protrusion end surface 170 changes until after the large electrical signal does not change. Therefore, by making the areas of the protrusion end surfaces 170 different from each other, the combined value of the large and small electrical signals is output as the pressure detection signal. As a result, according to the present embodiment, it is possible to realize the wide-range pressure sensor 1 that can measure the wide range from low pressure to high pressure.

The configuration for changing the characteristics related to the resistance of the sensor device in the stack circuit S is not limited to changing the area of the protrusion end surface 170. In the present embodiment, for example, the thickness, the surface roughness, electrical resistance profile (how to change) or the like of the conductive film 15 can be changed. In this way, it is conceivable to change the characteristics related to the resistance of the sensor device. Further, in the present embodiment, for example, it is conceivable to change the characteristics related to the resistance of the sensor device by changing the thickness, hardness or the like of the protrusion 17a.

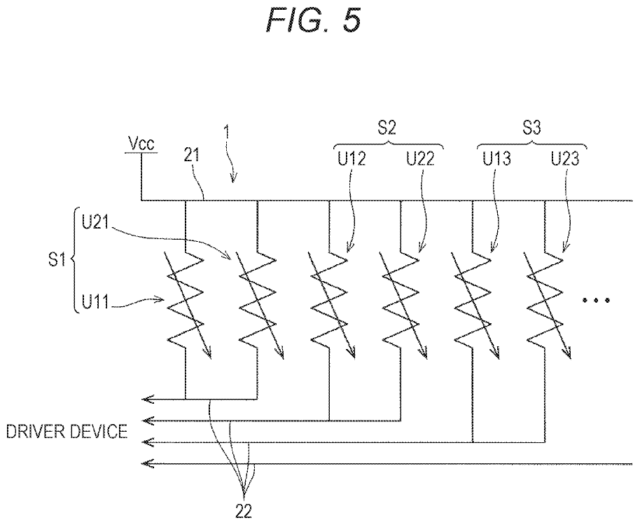

In the present embodiment, the pressure measurement range of the pressure sensor 1 can be increased by connecting the plurality of sensor devices included in the stack circuit S in parallel to each other. FIG. 4 is a top view showing the pressure sensor 1 of the present embodiment including the plurality of stack circuits shown in FIGS. 1, 2(a) and 2(b), that is connected in parallel. FIG. 5 is a diagram showing an equivalent circuit of the pressure sensor 1 shown in FIG. 4. The illustrated pressure sensor 1 includes the plurality of sensor devices. The stacked sensor device U11 and the sensor device U21 form a stack circuit S1. The sensor device U12 and the sensor device U22 constitute a stack circuit S2. The sensor device U13 and the sensor device U23 constitute a stack circuit S3. A pair of sensor devices included in each stack circuit is connected in parallel to each other. According to such a configuration, in the present embodiment, a ratio of resistance characteristic of each sensor device constituting the stack circuit to the combined resistance is reduced. Thus, the electrical signal output from the stack circuit can be changed gently. In the present embodiment, when the stack circuit includes the plurality of sensor devices having different resistance characteristics, the stack circuit can be designed such that the combined resistance changes continuously.

In the present embodiment, the stack circuit S1 to a stack circuit S8 are connected in parallel to each other. In this way, in the present embodiment, the driver device (not shown) can obtain the detection signal of the pressure from each of the stack circuits. At this time, the driver device may include the same number of input channels as the number of stack circuits. Or the driver device may include fewer input channels than the number of stack circuits. When the driver device has fewer input channels than the number of stack circuits, the driver device may be designed to sequentially and repeatedly obtain detection signals output from the stack circuits at a frequency of, for example, about 300 Hz.

### [Manufacturing Method of Pressure Sensor]

FIG. 6(a), FIG. 6(b), and FIG. 6(c) are views for explaining a method for manufacturing the pressure sensor of the present embodiment. FIG. 6(a) is a top view of a pressure sensor member 100. The pressure sensor member 100 has the stack circuits S1 to S8 on the wiring sheet 10. Each of the stack circuit S1 to the stack circuit S8 includes paired two sensor devices such as the sensor devices U11 and U21, sensor devices U12 and U22, and the like. As described above, the sensor device includes the electrodes 19a and 19b and the conductive film 15 disposed to face the electrodes 19a and 19b. The pressure sensor member 100 includes the common input line 21 that inputs the electrical signals to the sensor devices U11, U21, and the like, and the common output line 22 that outputs the electrical signals from the sensor devices U11, U21, and the like. From this, the method for manufacturing the pressure sensor member 100 includes a process for forming on the wiring sheet 10, the electrodes 19a and 19b, the conductive film 15 disposed facing the electrodes 19a and 19b, the common input line 21 for inputting the electrical signals to the sensor devices U11, U21, and the like, and the common output line 22 for outputting the electrical signals from the sensor devices U11, U21, and the like.

As shown in FIG. 6(c), the electrodes 19a and 19b of the sensor devices U11 and U12 are arranged facing each other inwardly with the conductive film 15 therebetween. The insulating sheet 16 is disposed on the entire surface between the conductive films 15 so that the two conductive films 15 are not electrically short-circuited. The insulating sheet 16 can be made of the same material as the wiring sheet 10 described above, such as polyimide or polyamideimide. The wiring sheet 10 and the insulating sheet 16 may be made of the same material or different materials.

Next, the above process will be described in more detail. The pressure sensor member 100 includes sensor devices U11 to U18 and sensor devices U21 to U28 constituting the stack circuit S1 to the stack circuit S8. In a process for manufacturing the pressure sensor member 100, through-holes h1 and h2 for electrically conducting front and back of the wiring sheet 10 are formed in the wiring sheet 10. Then, the both surfaces of the wiring sheet 10 and inner surfaces in a thickness direction in the through-holes h1 and h2 are made conductive by plating or the like. Through the above steps, the front and back of the wiring sheet 10 can be made conductive.

Next, in the method for manufacturing the pressure sensor of the present embodiment, an etching resist film is laminated on the wiring sheet 10. Then, by exposing and developing the resist film, an etching mask having a pattern including the input line 21, the output line 22, and the electrodes 19a and 19b is formed on the wiring sheet 10. In the present embodiment, plating foil that is not covered with the etching mask is removed from the wiring sheet 10 by etching the plating foil using the etching mask as a mask. The etching mask is peeled off after completing etching of the plating foil. Through the above steps, a metal pattern of the input line 21, the output line 22, and the electrodes 19a and 19b can be formed on the wiring sheet 10.

After the above processing, in the present embodiment, in order to protect the formed input line 21, output line 22 and the like, a cover film is laminated on a formation surface of the input line 21 and output line 22 in the wiring sheet 10. And a soldering resist is printed on the formation surface, and this is exposed and developed, to form the insulating layer 13. A wiring protective layer can be formed by the above steps. Then, surfaces of the electrodes 19a and 19b facing the conductive film 15 are plated with nickel, gold or the like. Further, in the present embodiment, the conductive film 15 is bonded to the insulating layer 13 using the adhesive layer 11. The pressure sensor member 100 is completed through the above steps.

Further, the method for manufacturing the pressure sensor of the present embodiment includes a step of stacking the sensor devices U11 and U21 by folding the pressure sensor member 100 which is the wiring sheet 10 that has undergone the above steps. FIG. 6(b) and FIG. 6(c) are views for explaining the above steps. FIG. 6(b) is a perspective view of the pressure sensor member 100 in a process of being folded, and FIG. 6(c) is a schematic view of a cross-section obtained when the folded pressure sensor member 100 is cut on the sensor devices U11 and U12 in a direction perpendicular to a line L1 in FIG. 6(a). In the wiring sheet 10, one side (a lower side in FIG. 6(a)) folded at the line L1 is referred to as a partial region 10a, and the other side (upper side in FIG. 6(a)) is referred to as a partial region 10b. The plurality of sensor devices included in each of the stack circuits is individually arranged in each of the partial region 10a and the partial region 10b by one. For example, in FIG. 6(a), the sensor device U21 out of the two sensor devices U11 and U21 included in the leftmost stack circuit S1 is disposed in the partial region 10a. On the other hand, the sensor device U11 is disposed in the partial region 10b.

The through-holes h1 and h2 are respectively formed in the partial regions 10a and 10b. The through-holes h1 and h2 are formed at positions where they overlap each other when the wiring sheet 10 is folded along the line L1. Specifically, distances from centers of the through-holes h1 and h2 to the line L1 are equal to each other. Further, an arrangement direction of the through-holes h1 and h2 is perpendicular to the line L1. Thus, when the wiring sheet 10 is folded along the line L1, it is possible to suppress the partial region 10a and the partial region 10b from deviating from each other by putting an instrument such as a pin (not shown) into the through-holes h1 and h2. In this way, these partial regions can overlap each other while being aligned.

As shown in FIG. 6(b), in the present embodiment, the pressure sensor member 100 is folded in a width direction thereof along the line L1. When the pressure sensor member 100 is folded, two sensor devices (for example, the sensor devices U11 and U21) in each (for example, the stack circuit S1) of the plurality of stack circuits are stacked on each other. Thus, the stack circuit (for example, the stack circuit S1) is formed. In the method for manufacturing the pressure circuit of the present embodiment, the pressure sensor member 100 is folded along the line L1 so that formation surfaces of the sensor devices U11 and U21 are on its inside. Therefore, the stacked sensor devices U11 and U21 are arranged so that the conductive films 15 overlap each other as shown in FIG. 6(c). Further, in the present embodiment, the pressure sensor is completed by bonding the electrode pressing material 17 to one wiring sheet 10 of the sensor devices U11 and U21.

According to the method for manufacturing the pressure sensor of the present embodiment described above, the plurality of sensor devices can be formed at once and stacked on each other. Therefore, the process can be simplified. Further, a configuration in which the electrodes 19a and 19b are directly formed in the wiring sheet 10 is advantageous in reducing the thickness of the pressure sensor. However, the present embodiment is not limited to folding the pressure sensor member 100 so that the formation surfaces of the sensor devices U11 and U21 are on the inside. In the present embodiment, the pressure sensor member 100 may be folded so that the formation surfaces of the sensor devices U11 and U21 are on the outside. In this case, the sensor devices U11 and U21 are stacked on each other so that the wiring sheets 10 overlap each other. Further, the present embodiment is not limited to providing the electrode pressing material 17 on one side of the stack circuit. The electrode pressing material 17 may be formed on both sides of the stack circuit. In the present embodiment, the sensor device may be stacked by folding the pressure sensor member 100 after providing the electrode pressing material 17 on the sensor device.

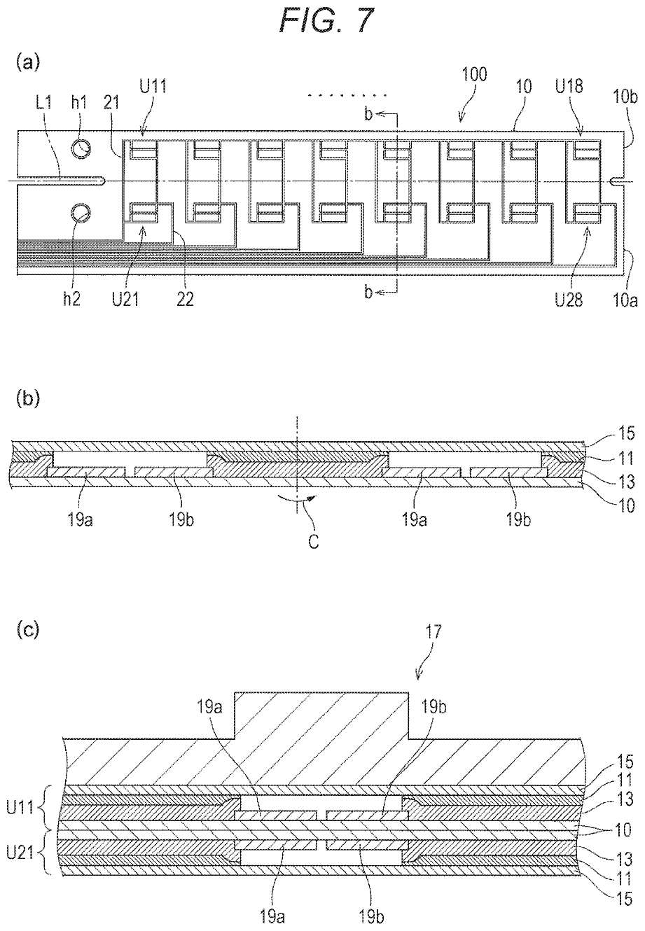

FIG. 7(a), FIG. 7(b), and FIG. 7(c) are other views for explaining the method for manufacturing the pressure sensor of the present embodiment. FIG. 7(a) is a top view of the pressure sensor member 100, and FIGS. 7(b) and 7(c) are views for explaining a process of stacking the sensor devices U11 and U21 by folding the pressure sensor member 100. FIG. 7(b) is a cross-sectional view of the pressure sensor member 100 taken along an arrow line b-b shown in FIG. 7(a). FIG. 7(c) is a view showing a state in which the sensor devices are stacked on each other by folding the pressure sensor member 100 shown in FIG. 7(b) in a direction of an arrow line c in FIG. 7(b). In the pressure sensor shown in FIG. 6(c), the pressure sensor member 100 is valley-folded at the line L1. In contrast, in the pressure sensor shown in FIG. 7(c), the pressure sensor member 100 is folded to form a mountain at the line L1. In the pressure sensor shown in FIG. 6(c), the sensor device U11 and the sensor device U12 are stacked on each other so that their conductive films 15 are all disposed inside the wiring sheet 10. On the other hand, in the pressure sensor shown in FIG. 7(c), the sensor device U11 and the sensor device U12 are stacked on each other so that their conductive films 15 are all disposed outside the wiring sheet 10. In this respect, the pressure sensor of FIG. 7(c) is different from the pressure sensor of FIG. 6(c).

Further, the pressure sensor member 100 used in the present embodiment is not limited to a member that is folded along only one line L1. The pressure sensor member 100 may be folded multiple times along a plurality of lines. FIG. 8(a), FIG. 8(b), and FIG. 8(c) are views for explaining an example in which the pressure sensor member 101 is folded three times in a bellows shape. FIG. 8(a) is a top view of the pressure sensor member 101. FIG. 8(b) is a perspective view of the pressure sensor member 101 in the process of being folded. FIG. 8(c) is a schematic view of a cross-section obtained by cutting the folded pressure sensor member 101 in a direction perpendicular to the line L1 in the drawing and at a position passing through the sensor devices U11, U21, U31, U41. The pressure sensor member 101 shown in FIG. 8(a) includes 32 sensor devices U11 to U18, U21 to U28, U31 to U38, and U41 to U48. As shown in FIG. 8(b), the pressure sensor member 101 is folded along each of the three lines L1, L2, and L3. At this time, in the present embodiment, the pressure sensor member 101 is valley-folded along the line L1. Thus, the sensor device U11 and the sensor device U21 are stacked on each other. And the pressure sensor member 101 is mountain-folded along the line L2. Thus, the sensor device U11 and the sensor device U41 are stacked on each other. Further, the pressure sensor member 101 is valley-folded along the line L3. Thus, the sensor device U41 and the sensor device U31 are stacked on each other.

In the wiring sheet 10 of the pressure sensor member 101, four regions partitioned by the lines L1 to L3 are referred to as partial regions 10a to 10d. Specifically, a region on one side of the line L1 (a lower side in FIG. 8(a)) is referred to as the partial region 10a. A region surrounded by the lines L1 and the line L2 is referred to as the partial region 10b. A region surrounded by the line L2 and the line L3 is referred to as the partial region 10c. A region on the other side (an upper side in FIG. 8(a)) of the line L3 is referred to as the partial region 10d. The plurality of sensor devices respectively included in the stack circuits is respectively arranged in one and the other of the two partial regions adjacent to each other and partitioned by one of the lines L1 to L3, out of the partial regions 10a to 10d. For example, in an example of FIG. 8(a), out of the four sensor devices U11, U21, U31, and U41 included in the leftmost stack circuit, the sensor devices U21 and U11 are respectively arranged in the partial regions 10a and 10b partitioned by the line L1. Then, the sensor devices U41 and U31 are respectively arranged in the partial regions 10c and 10d partitioned by the line L3.

The partial regions 10a to 10d respectively have through-holes h1 to h4 penetrating the wiring sheet corresponding to the partial regions. The through-holes h1 to h4 are formed at positions where they overlap each other when the wiring sheet 10 is folded along the lines L1 to L3. Specifically, distances from centers of the through-holes h1 and h2 to the line L1 are equal to each other. The distances from the centers of the through-holes h1 and h4 to the line L2 are also equal to each other. Further, the distances from the centers of the through-holes h3 and h4 to the line L3 are also equal to each other. Then, an arrangement direction of the through-holes h1 to h4 is perpendicular to the lines L1 to L3 that are parallel to each other. According to the present embodiment, when the wiring sheet 10 is folded along the lines L1 to L3 and the partial regions 10a to 10d are sequentially stacked, the instrument such as the pin (not shown) can be inserted into the through-holes h1 to h4. Thus, it is possible to suppress the partial regions 10a to 10d from deviating from each other.

However, the present embodiment is not limited to a configuration including the sensor devices that are stacked on each other by folding the pressure sensor members 100 and 101. By overlapping the wiring sheets 10 including the sensor devices, the input lines 21, and the output lines 22, the input lines 21 or the output lines 22 may be connected to each other through the through-hole h1 and the like. Further, when the plurality of stack circuits S is arranged in the plane direction as shown in FIG. 4, in the present embodiment, one electrode pressing material 17 can be disposed corresponding to the plurality of stack circuits S arranged in the plane direction.

As described above, in the pressure sensor according to the present embodiment, the plurality of sensor devices is stacked in the direction in which the conductive film is disposed against the electrodes of the sensor device. This is suitable for reducing the footprint of the pressure sensor. In addition, by providing the common input line and the common output line for the plurality of sensor devices, a signal corresponding to a voltage drop caused by the combined resistance of the plurality of sensor devices can be output as the pressure detection signal. Therefore, the signal corresponding to the voltage drop caused by the combined resistance of the resistance value detected by each sensor device can be output as the detection signal. In this way, a wide range of pressures from a relatively low pressure to a relatively high pressure can be detected.

In particular, in the present embodiment, even if the sensor devices are stacked on each other in the thickness direction of the wiring sheet 10 by forming the pressure sensor 1 in the wiring sheet 10, the entire pressure sensor 1 can be made thinner than a known configuration including, for example, mounted components such as tact switches or the like stacked in the thickness direction. Further, in the present embodiment, the sensor devices are stacked by folding the formed pressure sensor members 100 and 101. Thus, the number of electrical connection points can be reduced. As a result, a degree of freedom in design can be increased.

### [Modifications]

### (Modification 1)

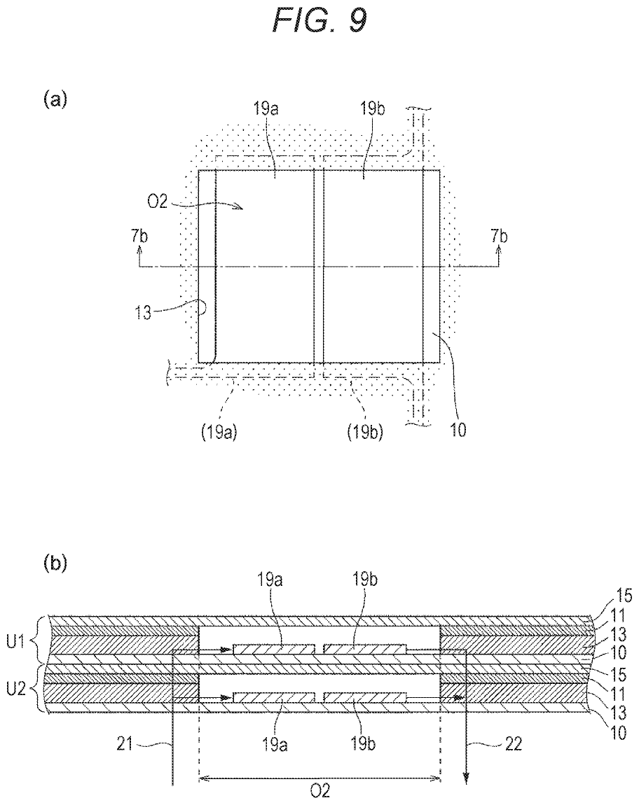

Further, the present embodiment is not limited to the embodiments described above. For example, the insulating layer 13 is not limited to an insulating layer formed to partially overlap peripheral edges of the electrodes 19a and 19b. As shown in FIGS. 9(a) and 9(b), offsets may be provided between the peripheral edges of the electrodes 19a, 19b and the insulating layer 13. In such a case, an opening O2 of the insulating layer 13 is designed to be slightly larger than the peripheral edges of the electrodes 19a and 19b. For the sake of convenience, a dot pattern is added for convenience to a formation region of the insulating layer 13 in FIG. 9(a) as in FIG. 2(a). The electrodes 19a and 19b are entirely separated from the insulating layer 13 in an adjacent arrangement direction (a left-right direction in FIGS. 9(a) and 9(b)). As shown in FIG. 9(a), in a direction perpendicular to the arrangement direction (the up-down direction in FIG. 9(a)), a part of end portions of the electrodes 19a and 19b may overlap the insulating layer 13 and be covered therewith. According to Modification 1 described above, it is possible to suppress variations in characteristics of the sensor device due to positional deviation between the opening O1 and the electrodes 19a, 19b.

### (Modification 2)

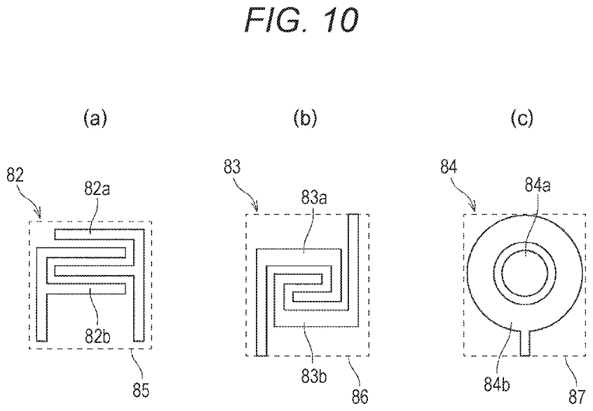

Further, the present embodiment is not limited to a configuration including the rectangular electrodes 19a and 19b that are adjacently arranged in parallel with a predetermined distance as shown in FIG. 2(a). In the present embodiment, the electrodes may include a first electrode and a second electrode, and the first electrode and the second electrode may be separated from each other and have a shape that can be fitted to each other. Here, the shape that can be fitted to each other means that all straight lines passing through an envelope region of the first electrode and the second electrode (the smallest rectangular region including the first electrode and the second electrode) intersect at least one of the first electrode and the second electrode. FIGS. 10(a), 10(b), and 10(c) are views for explaining the electrodes of the second modification. A first electrode 82a and a second electrode 82b of an electrode 82 shown in FIG. 10(a) have a comb-teeth shape mating with each other. A first electrode 83a and a second electrode 83b of an electrode 83 shown in FIG. 10(b) have a spiral shape mating with each other. The first electrode 83a and the second electrode 83b of the electrode 83 shown in FIG. 10(c) are arranged concentrically with each other. Specifically, one of the first electrode 83a and the second electrode 83b may have a circular shape, and the other may have a ring shape surrounding the circular shape with a predetermined distance. The circular shape includes a perfect circle, an oval, and an ellipse.

In Modification 2 shown in FIGS. 10(a) to 10(c), in any of the electrodes 82, 83, 84, all straight lines intersecting the envelope regions 85, 86, 87 including the first electrode and the second electrode intersect at least one of the first electrode and the second electrode. According to the electrodes of Modification 2, the change in the resistance value when the pressure is applied changes according to a shape of the electrodes. Therefore, detection accuracy of the pressure sensor can be increased by combining the electrodes having different shapes.

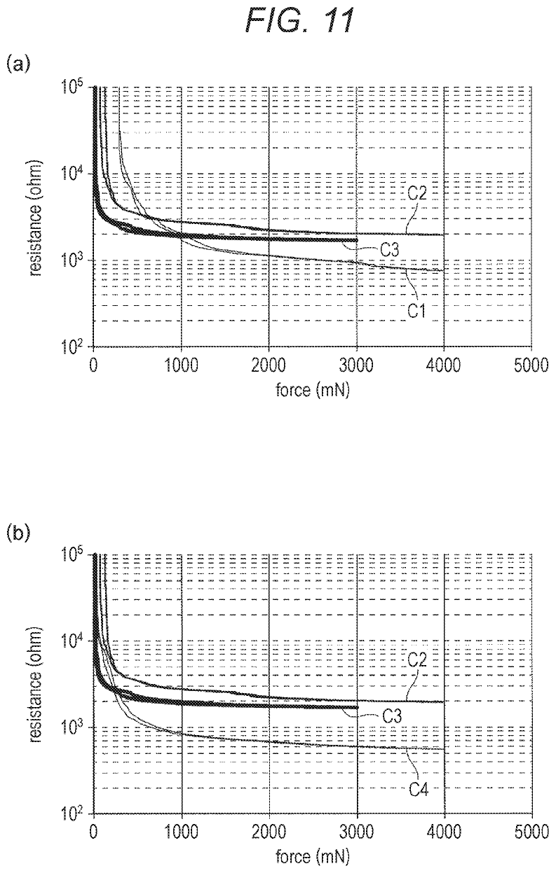

Effects of the pressure sensor described above can be verified by experiments. Results of the experiments will be described below as an example. In the experiments, the pressure sensor according to the present embodiment having a configuration including the electrode pressing material 17 provided in each of the stacked sensor devices was used. Further, the characteristics of the pressure sensor according to the present embodiment were compared with those of the single sensor device that is not stacked. FIGS. 11(a) and 11(b) are diagrams illustrating the results of the experiments for verifying the effects of stacking the sensor devices. In any of FIGS. 11(a) and 11(b), a vertical axis represents the detection signal (resistance value: S2) output from the pressure sensor, and a horizontal axis represents the pressure (mN) applied to the pressure sensor. A curve C1 in FIG. 11(a) indicates the characteristics of the pressure sensor according to the present embodiment. Curves C2 and C3 indicate the characteristics of Comparative Example 1 and Comparative Example 2 that are both compared with the pressure sensor according to the present embodiment.

In the pressure sensor according to the present embodiment, the results of which is shown in FIG. 11(a), the four sensor devices designed in the same manner are stacked and connected in parallel. Then, the electrode pressing material 17 is provided in each of the stacked sensor devices. The protrusion end surfaces of the protrusions 17a of the electrode pressing materials 17 are all circular with a diameter of 4 mm. In the pressure sensor of Comparative Example 1 having characteristics of a curve C2, the electrode pressing material 17 is provided on the same single sensor device as the sensor device included in the pressure sensor according to the present embodiment. The protrusion 17a has a circular protrusion end surface with a diameter of 4 mm. In the pressure sensor of Comparative Example 2, the electrode pressing material 17 is provided on the single sensor device. The protrusion 17a has the circular protrusion end surface with a diameter of 2 mm According to FIG. 11(a), in the curve C2 of Comparative Example 1, when the pressure reaches about 3000 mN, the resistance value (resistance) hardly changes. Further, in a curve C3 of Comparative Example 2, when the pressure reaches about 1000 mN, the resistance value hardly changes. In contrast, it was confirmed from the curve C1 shown by the pressure sensor according to the present embodiment that the resistance value changed significantly until the pressure reached about 4000 mN.

In the pressure sensor according to the present embodiment, the results of which is shown in FIG. 11(b), four sensor devices designed in the same manner are stacked and connected in parallel. Then, the electrode pressing material 17 is provided in each of the stacked sensor devices. The protrusion end surfaces of the protrusions 17a of the electrode pressing materials 17 are all circular with a diameter of 2 mm A curve C4 in FIG. 11(b) shows the characteristics of the pressure sensor according to the present embodiment described above. According to FIG. 11(b), it was confirmed from the curve C4 shown by the pressure sensor according to the present embodiment that the resistance value changed until the pressure reached about 4000 mN. From the above experiments, it was confirmed that the pressure sensor according to the present embodiment had a detection range wider than that of the pressure sensor of the single sensor device because a plurality of stacked sensor devices is connected in parallel.

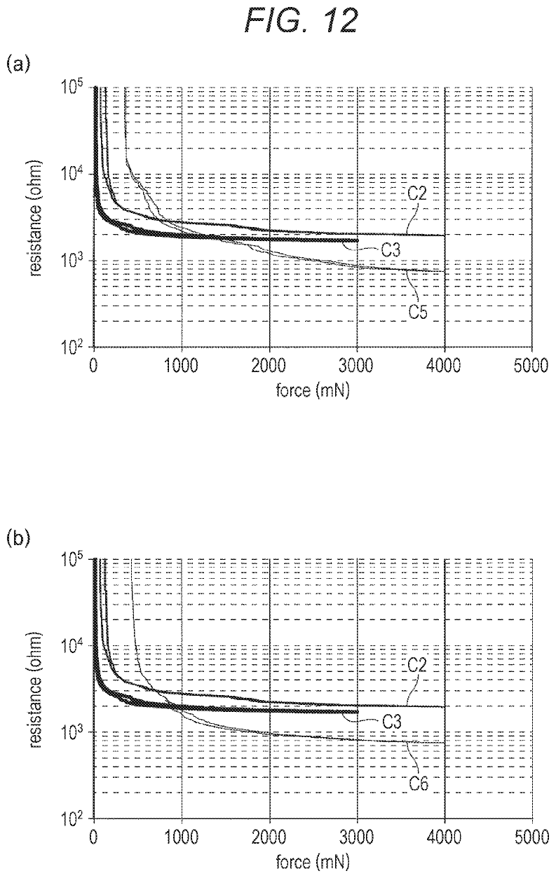

FIGS. 12(a) and 12(b) are diagrams for explaining the results of the experiments for verifying effects of changing electrical characteristics of the plurality of stacked sensor devices in the stack circuit. In any of FIGS. 12(a) and 12(b), the vertical axis represents the detection signal (resistance value: S2) output from the pressure sensor, and the horizontal axis represents the pressure (mN) applied to the pressure sensor. A curve C5 in FIG. 11(a) indicates the characteristics of the pressure sensor according to the present embodiment. In the pressure sensor according to the present embodiment, the result of which is shown in FIG. 12(a), four sensor devices designed in the same manner are stacked and connected in parallel. The electrode pressing material 17 is provided in each of the stacked sensor devices. The protrusions 17a of the three sensor devices out of the four sensor devices have the circular protrusion end surface with a diameter of 4 mm. The protrusion 17a of the remaining one sensor device has the circular protrusion end surface with a diameter of 2 mm According to FIG. 12(a), it was confirmed from the curve C5 shown by the pressure sensor according to the present embodiment that the resistance value changed until the pressure reached about 4000 mN.

In the pressure sensor according to the present embodiment, the results of which is shown in FIG. 12(b), the four sensor devices designed in the same manner are stacked and connected in parallel. Then, the electrode pressing member 17 is provided in each of the stacked sensor devices. The protrusions 17a of the two sensor devices out of the four sensor devices have the circular protrusion end surfaces with a diameter of 4 mm. The protrusions 17a of the remaining two sensor devices have the circular protrusion end surfaces with a diameter of 2 mm. A curve C6 in FIG. 12(b) shows the characteristics of the pressure sensor according to the present embodiment described above. According to FIG. 12(b), it was confirmed from the curve C6 shown by the pressure sensor according to the present embodiment that the resistance value changed until the pressure reached about 4000 mN. From the above experiments, it was confirmed that the pressure sensor according to the present embodiment had the detection range wider than that of the pressure sensor of the single sensor device because the plurality of stacked sensors is connected in parallel and the resistance characteristics are changed between the plurality of sensor devices.

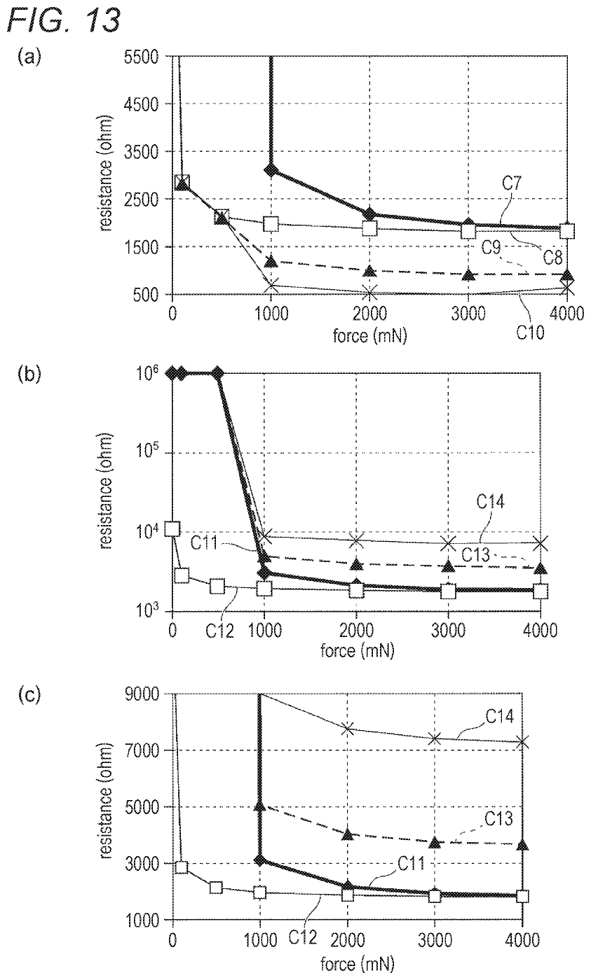

FIGS. 13(a) to 13(c) are diagrams showing the results of theoretical calculation of a relationship between the detection signal (resistance value: S2) output from the pressure sensor and the applied pressure. In any of FIGS. 13(a) to 13(c), the vertical axis represents the detection signal (resistance value: S2) output from the pressure sensor, and the horizontal axis represents the pressure (mN) applied to the pressure sensor. FIG. 13(a) is a diagram for explaining effects of connecting the stacked sensor devices in parallel. A curve C7 shown in FIG. 13(a) shows the characteristics of the pressure sensor of the single sensor device (hereinafter referred to as a sensor device p1) having predetermined characteristics. A curve C8 shows the characteristics of the pressure sensor of the single sensor device (hereinafter referred to as a sensor device p2) having characteristics related to a resistance different from that of the sensor device p1. A curve C9 shows the characteristics of the pressure sensor in which the sensor device p1 and the sensor device p2 are stacked and connected in parallel. Further, a curve C10 shows the characteristics of the pressure sensor in which three sensor devices p1 and one sensor device p2 are combined, stacked and connected in parallel.

As shown by the curves C9 and C10 in FIG. 13(a), the pressure sensors in which the sensor devices having characteristics related to different resistances are stacked and connected in parallel have a measurable pressure range wider than that of the pressure sensor of the single sensor device, regardless of the number of stacked sensor devices. Further, it can be understood that the detection signal changes more greatly when the number of stacked sensor devices is large, in a range of the applied pressure up to about 1000 mN.

FIG. 13(b) is a diagram for explaining the effect of stacking the sensor devices and connecting them in series. FIG. 13(c) is an enlarged view of a region where the detection signal (resistance value: S2) is low in FIG. 13(b). A curve C11 shown in FIGS. 13(b) and 13(c) shows the characteristics of the pressure sensor of the single sensor device (hereinafter referred to as a sensor device p3) having characteristics related to a resistance different from that of the sensor devices p1 and p2. A curve C12 shows the characteristics of the pressure sensor of the single sensor device (hereinafter referred to as a sensor device p4) having characteristics related to a resistance different from that of any of the sensor devices p1, p2, and p3. A curve C13 shows the characteristics of the pressure sensor in which the sensor device p3 and the sensor device p4, which have characteristics related to different resistances, are stacked and connected in series. Further, a curve C14 shows the characteristic of the pressure sensor in which three sensor devices p3 and one sensor device p4 are combined, stacked and connected in series.

As shown in FIGS. 13(b) and 13(c), the pressure sensor in which the sensor devices having characteristics related to different resistances are stacked and connected in series outputs the detection signal similar to that of the pressure sensor of the single sensor device when the applied pressure is within 1000 mN. However, the detection signal of the pressure sensor in which the sensor devices are stacked and connected in series changes with a larger inclination than that of the pressure sensor of the single sensor device, particularly in a range where the applied pressure is 3000 mN or more. From the above, it can be understood that the pressure sensor according to the present embodiment can measure a wider range of pressures than the pressure sensor of the single sensor device.

As shown in FIG. 13(a), it has been found that when the plurality of sensor devices is connected in parallel, a change width of characteristics related to the resistance is larger than that of the single sensor device. In contrast, as shown in FIGS. 13(b) and 13(c), it has been found that when the plurality of sensor devices is connected in series, the change width of characteristics related to the resistance is smaller than that of the single sensor device. Therefore, the pressure sensor in which the plurality of sensor devices is connected in parallel can be said to be more preferable because a wider dynamic range can be obtained.

The above embodiments and examples include the following technical ideas.

(1) A pressure sensor including a wiring sheet, in which a plurality of sensor devices having electrodes and a conductive film disposed to face the electrodes are stacked in an arrangement direction of the conductive film against the electrodes, and a common input line for inputting electrical signals to the plurality of sensor devices, and a common output line for outputting the electrical signals from the plurality of sensor devices are formed.
(2) The pressure sensor according to (1) in which the electrodes are formed on the wiring sheet
(3) The pressure sensor according to (1) or (2), in which at least some of the sensor devices include a protrusion that overlaps at least a part of the electrodes.
(4) The pressure sensor according to (3), in which the protrusions are respectively provided on the plurality of sensor devices stacked.
(5) The pressure sensor according to (4), in which an end surface of some of the protrusions is different in size from at least one end surface of the other protrusions.
(6) The pressure sensor according to (4), in which the one protrusion is provided corresponding to the plurality of sensor devices stacked.
(7) The pressure sensor according to any one of (1) to (6), in which characteristics related to a resistance of some of the plurality of stacked sensor devices are different from the characteristics related to the resistance of the other sensor devices.
(8) The pressure sensor according to (7), in which an area of the electrodes that can be in contact with the conductive film of some of the plurality of the stacked sensor devices is different from that of the other sensor devices.
(9) The pressure sensor according to any one of (1) to (8), in which the plurality of stacked sensor devices is connected in parallel to each other.
(10) The pressure sensor according to any one of (1) to (9), in which the electrodes include a first electrode and a second electrode, and the first electrode and the second electrode are separated from each other and have a shape that can be fitted together.
(11) A method for manufacturing a pressure sensor, including a step of forming on a wiring sheet, sensor devices each having a plurality of electrodes and a conductive film corresponding to at least some of the plurality of electrodes, a common input line for inputting electrical signals to the sensor devices, and a common output line for outputting the electrical signals from the sensor devices, and a step of stacking the sensor devices by folding the wiring sheet.

### LIST OF REFERENCE NUMERALS

1: pressure sensor, 10: wiring sheet, 10a, 10b, 10c, 10d: partial region, 11: adhesive layer, 13: insulating layer, 15: conductive film, 16: insulating sheet, 17: electrode pressing material, 17a: protrusion, 17b: base portion, 19a, 19b, 82, 83, 84: electrode, 21: input line, 22: output line, 24: through-hole, 82a, 83a, 84a: first electrode, 82b, 83b, 84b: second electrode, 85, 86, 87: envelope region, 100, 101: pressure sensor member.

1. A pressure sensor comprising:
a plurality of sensor devices; and
a wiring sheet, wherein
each of the plurality of sensor devices includes electrodes and a conductive film disposed to face the electrodes,
the plurality of sensor devices is stacked in a direction in which the conductive film is disposed against the electrodes, and
the wiring sheet includes a common input line for inputting electrical signals to the plurality of sensor devices, and a common output line for outputting the electrical signals from the plurality of sensor devices.

2. The pressure sensor according to claim 1, wherein the electrodes are formed on the wiring sheet.

3. The pressure sensor according to claim 1, wherein at least some of the sensor devices comprise a protrusion that overlaps at least a part of the electrodes.

4. The pressure sensor according to claim 3, wherein the protrusions are respectively provided on the plurality of sensor devices.

5. The pressure sensor according to claim 4, wherein an end surface of at least one of the protrusions has a size different from that of the end surface of at least remaining one of the protrusions.

6. The pressure sensor according to claim 4, wherein the one protrusion is provided corresponding to the plurality of sensor devices.

7. The pressure sensor according to claim 1, wherein characteristics related to a resistance of at least one sensor device out of the plurality of sensor devices are different from the characteristics related to the resistance of at least remaining one sensor device out of the plurality of sensor devices.

8. The pressure sensor according to claim 7, wherein an area of the electrodes that can be in contact with the conductive film of at least one sensor device out of the plurality of sensor devices is different from the area of the electrodes that can be in contact with the conductive film of at least remaining one sensor device out of the plurality of sensor devices.

9. The pressure sensor according to claim 1, wherein the plurality of sensor devices is connected in parallel to each other.

10. The pressure sensor according to claim 1, wherein the electrodes include a first electrode and a second electrode, and the first electrode and the second electrode are separated from each other and have a shape that can be fitted together.

11. A method for manufacturing a pressure sensor, comprising:
forming on a wiring sheet, sensor devices each including a plurality of electrodes and a conductive film corresponding to at least one electrode of the plurality of electrodes, a common input line for inputting electrical signals to the sensor devices, and a common output line for outputting the electrical signals from the sensor devices, and
stacking the sensor devices by folding the wiring sheet.
